(19) United States
(12) Patent Application Publication
(10) Pub. No.: US 2008/0209220 A1
(43) Pub. Date: Aug. 28, 2008

(54) Method of Quantization-Watermarking

(75) Inventors: Job Cornelis Oostveen, Eindhoven (NL); Jean-Christophe Paul Durand, Zurich (CH)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/909,737

(22) PCT Filed: Mar. 30, 2006
(86) PCT No.: PCT/IB2006/050960

§ 371 Date: Sep. 26, 2007

(30) Foreign Application Priority Data
Apr. 1, 2005 (EP) 05102575.7

(51) Int. Cl. H04L 9/32

(52) U.S. Cl. 713/176

(57) ABSTRACT

There is provided a method of detecting a watermark included in a signal by way of quantization index modulation (QIM). The signal with the embedded watermark may have been geometrically transformed (e.g. spatially or temporally scaled) prior to detection. In order to detect the watermark even in such case, the embedder imposes an autocorrelation structure onto the embedded watermark data, for example by tiling. Initially, the detector applies conventional QIM detection. This step yields a first symbol vector, which corresponds to the embedded data when the signal was not tampered with, but does not correspond to the embedded data when the signal was subject to scaling. For example, when one data bit is embedded in each pixel of an image, 50% upsampling of the image causes a QIM detector to retrieve 3 data bits out of 3 received pixels, that is 3 data bits out of 2 original image pixels. Surprisingly, the autocorrelation of the first symbol vector will give a peak for a particular geometric transformation (e.g. the particular scaling factor). In accordance with the invention, the detector calculates said autocorrelation function, and uses the result to apply the inverse of the transformation, i.e. undo the scaling. A second pass of the conventional QIM detection will subsequently receive the embedded data.

### FIELD OF THE INVENTION

The present invention relates to methods of quantization-watermarking audio-visual objects. Moreover, the invention relates to apparatus capable of executing the methods, and also to software executable on computing hardware for implementing the methods. Furthermore, the invention relates to audio-visual objects subject to quantization-watermarking according to the aforesaid methods.

### BACKGROUND TO THE INVENTION

Digital watermarking involves embedding auxiliary information into audio-visual objects, for example into audio-visual data objects and audio data objects. Such watermarking is pertinent when asserting copyright protection in regard of audio-visual objects, when royalty monitoring associated with distribution of such audio-visual objects, as well as when potentially providing an indication of authenticity to purchasers of the audio-visual objects. A classic approach to watermarking an audio-visual object comprising a signal s is to add a known noise-like signal w to generate a corresponding watermarked signal (w+s). Subsequent watermark detection is achieved by way of computing an autocorrelation resulting in the generation of a wanted term <s,s> and an interference term <s,w>. Noise-like signal addition is now regarded as a sub-optimal method of watermarking audio-visual objects.

Quantization-watermarking (QIM) provides a more advanced watermarking approach and is described in a publication “Scalar Costa Scheme for information embedding” by J. Eggers, R. Baüml, R. Tzchoppe and B. Girod, IEEE Transactions on Signal Processing, vol. 51, issue 4, year 2004 pp. 1003-1019 which is hereby incorporated by reference, for example for purposes of describing the present invention. Such QIM watermarking is concerned with a space S of host signals s wherein N sets of code points Cₙ are chosen; N is a parameter which is numerically equal to the number of messages to be embedded, namely a watermark payload. When implementing QIM watermarking, a message m is embedded in a host signal s by modifying the host signal s into a corresponding signal s′ such that:

(a) the signals s, s′ are mutually perceptually close; and
(b) the watermarked signal s′ is closer to a point in the set of code points Cₘ than to any other point in any of the other code sets Cₙ, subscripts n and m being of mutually dissimilar values.

A distance between the points of the code sets is conveniently referred to as grid parameter or quantization step D.

The aforementioned quantization-watermarking (QIM) provides watermarking methods and schemes employing dithered vector quantization and distortion compensation. A combination of such dithered vector quantization and distortion compensation gives rise to a class of techniques known as “distortion compensated quantization index modulation watermarking” which is conveniently abbreviated to DC-QIM.

Although known QIM-like watermarking schemes are capable of providing greatest payload capacity in the presence of white Gaussian additive noise, such schemes are found in practice to be vulnerable to practical attack, for example from counterfeiters. These practical attacks can comprise geometric transformations, for example time-base modifications applied to audio-visual signals, zooming, rotation and other affined transformations of video signals and still images. Thus, there arises a technical problem that QIM-like watermarking schemes are insufficiently robust to deliberate practical attack.

### SUMMARY OF THE INVENTION

It is an object of the invention to provide a watermarking scheme which is more robust to practical attack.

According to a first aspect of the invention, there is provided a method of detecting a watermark embedded in a signal, said watermark being included in the signal by way of quantization index modulation (QIM), the method comprising steps of:

(a) receiving the signal with the watermark embedded therein;
(b) applying QIM detection to the signal to derive there from a first symbol vector from the watermark;
(c) processing the first symbol vector to determine there from a geometric transformation applied to the received signal;
(d) applying an inverse of the geometrical transformation determined in step (c) to the received signal to generate a geometrically normalized received signal; and
(e) applying QIM detection to the geometrically normalized received signal to derive there from a second symbol vector representative of the watermark embedded in the received signal.

The invention is of advantage in that the watermark is more robust to practical attack, for example obscuration by way of affined transformation.

Preferably, step (c) of the method involves processing the first symbol vector by way of generating an autocorrelation thereof for determining the geometric transformation applied to the received signal.

Optionally, steps (b) and (e) of the method are operable to process the received signal when including one or more of: audio-visual data objects, audio data objects, images. The method is of benefit in that it is applicable to these types of data objects, which have become a most widely used contemporary manner of distributing program content.

According to a second aspect of the invention, there is provided a watermark detector operable to process a watermarked signal to generate a corresponding symbol vector representative of a watermark included in the watermarked signal, said detector being operable to process the watermarked signal according to the method of the first aspect of the invention, and said detector including a processor operable to process the watermark, said watermark being incorporated into the watermarked signal by way of quantization index modulation (QIM).

According to a third aspect of the invention, there is provided a method of embedding a watermark into a signal by way of quantization index modulation (QIM) to generate a corresponding watermarked signal, the method including steps of:

(a) imposing an autocorrelation structure onto the watermark; and
(b) embedding the at least one symbol vector in association with the watermark into the signal to generate the watermarked signal, said signal being subject to control of the distribution of lengths of runs of symbol vector values therein having mutually similar values.

Optionally, the method is operable to embed the watermark in the signal including at least one of: audio-visual data objects, audio data objects, images.

Optionally, the method is operable to apply run-length control to the at least one symbol vector by repeating one or more watermark symbol vector values over a pre-defined region of the signal.

Optionally, the method is operable to control the distribution of lengths of runs of symbol vector values having mutually similar values.

Optionally, the watermark is embedded into the watermarked signal with a dither factor, which has an amplitude which is less than a quantization interval used for the quantization index modulation (QIM).

According to a fourth aspect of the invention, there is provided an embedder for embedding a message vector representative of a watermark into a signal to generate a watermarked signal, the embedder being operable to execute the method according to the third aspect of the invention.

According to a fifth aspect of the invention, there is provided software stored on a data carrier and executable on computing hardware for implementing the method according to the first aspect of the invention.

According to a sixth aspect of the invention, there is provided software stored on a data carrier and executable on computing hardware for implementing the method according to the third aspect of the invention.

According to a seventh aspect of the invention, there is provided a watermarked signal generated according to the method as claimed in claim 6, said signal including one or more data objects disposed on a data carrier or for communication via a communication network.

It will be appreciated that features of the invention are susceptible to being combined in any combination without departing from the scope of the invention.

### DESCRIPTION OF THE DIAGRAMS

Embodiments of the invention will now be described, by way of example only, with reference to the following drawings wherein:

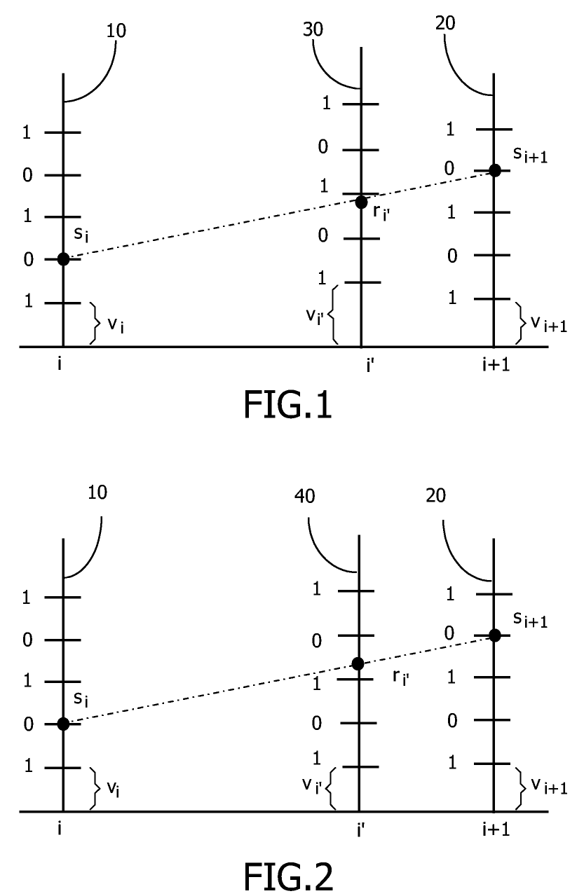

FIG. 1 is a schematic illustration of two neighboring pixels sᵢ, sᵢ₊₁ of a watermarked signal wherein both signals have been QIM encoded to embed a “0” value of watermark payload data;

FIG. 2 is an illustration of incorrect encoding caused by different sample values;

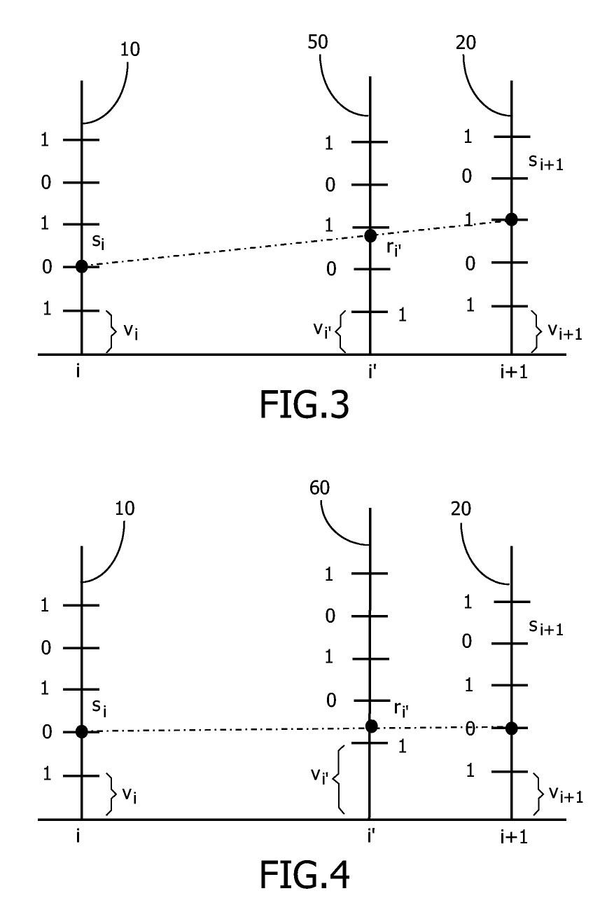

FIG. 3 is an illustration of incorrect encoding caused by different watermark payload message values;

FIG. 4 is an illustration of incorrect encoding caused by different dither values having been applied;

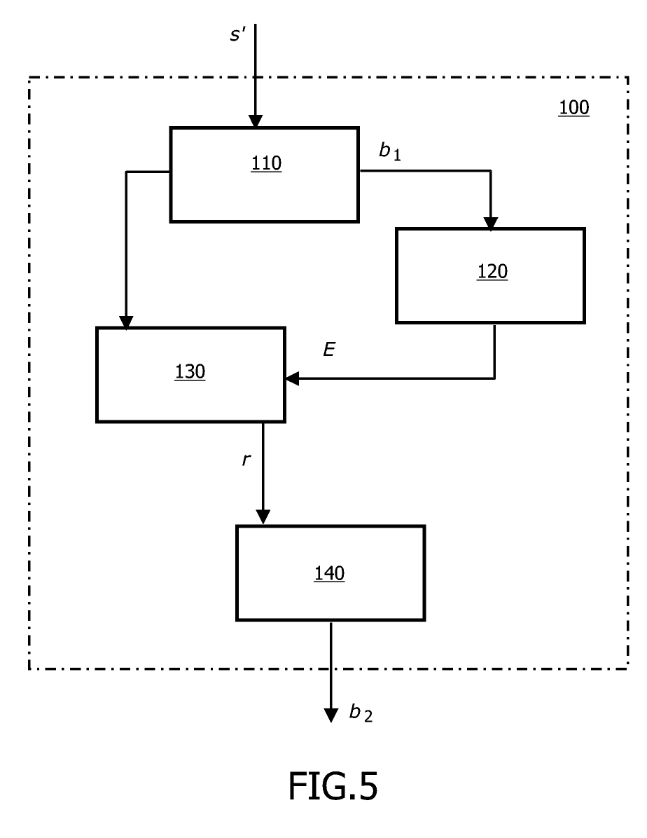

FIG. 5 is an illustration of a watermark detector according to the invention; and

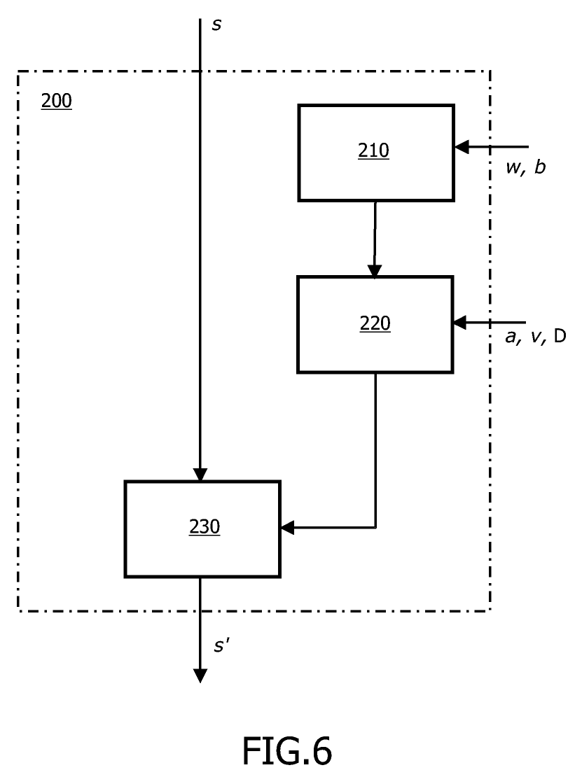

FIG. 6 is an illustration of a watermark embedder according to the invention.

### DESCRIPTION OF EMBODIMENTS OF THE INVENTION

In order to describe embodiments of the present invention in context, three established general approaches to render a watermark more resistant to geometric changes will firstly be elucidated.

In a first established approach to watermarking audio-visual objects known as “autocorrelation”, a watermark signal employed for watermarking an audio-visual object has a known autocorrelation. When such a watermark signal is added to the audio-visual object, scaling the resulting watermarked audio-visual object results in the autocorrelation function of the watermark signal included in the object being correspondingly deformed. When watermark detection is executed, an autocorrelation of the embedded watermark signal is estimated from the watermarked audio-visual object. The estimate of the autocorrelation function is compared to the known version of the autocorrelation function of the embedded watermark. From this comparison, it is possible to determine any deformation that may have been applied to the watermarked audio-visual object prior to performing watermark detection. Thereafter, a second attempt at performing watermark detection on the watermarked audio-visual object is performed taking the deformation into account.

In a second established approach to watermarking audio-visual objects, a reference signal is added to an audio-visual object to generate a corresponding watermarked audio-visual object; the reference signal is also known as a “registration template”. A subsequent geometrical transformation of the watermarked audio-visual object results in the reference signal included therein also being transformed but nevertheless easy to detect, thereby providing a measure of the transformation. An inverse transformation can then be applied to the transformed audio-visual object to generate a correctly scaled audio-visual object whose watermark signal can then be readily extracted. Use of such a registration template can be combined, for example, with the aforesaid first established approach.

In a third established approach, an audio-visual object is first transformed into an invariant domain, which is insensitive to relevant geometric distortions, for example to the frequency domain. A watermark signal is then added to the transformed audio-visual object to generate a corresponding transformed and watermarked audio-visual object. A corresponding reverse transform is then performed on the transformed watermarked audio-visual object to generate a watermarked version of the audio-visual object incorporating the watermark signal in reverse transformed state. At subsequent detection, the watermarked version of the audio-visual object is transformed to the invariant domain whereat the watermark signal is immediately detectable.

The aforesaid second and third approaches are susceptible to contributing to enhanced robustness of spread-spectrum watermarking systems as well as to aforementioned QIM watermarking schemes. Moreover, the first approach is adapted for coping with geometric transformations; the present invention is directed at addressing a problem that the first approach is impossible to straightforwardly combine with QIM. Such a problem arises on account of the first approach relying on a watermark embedder having full control over the signal w; by having by having full control, the embedder can ensure that the autocorrelation of the signal w satisfies a pre-determined correlation structure. In contradistinction, in QIM watermarking, the value of the signal w is not only determined by watermark parameters, but also by the host signal s. Thus, the embedder cannot straightforwardly impose a specific autocorrelation structure on the signal w. Furthermore, the inventors have appreciated that QIM-type watermarks are generally relatively sensitive to geometrical transformation, which can render these watermarks potentially undetectable. Thus, the inventors have appreciated that autocorrelation is a best approach but suffers a drawback that it cannot straightforwardly be combined with QIM watermarking.

In Quantization Index Modulation, there is chosen a fixed quantization interval D, and two code sets C₀ and C₁ are constructed; the interval D is also known as a quantization step. The code set C₀ consists of even multiples of the quantization interval D, whereas the code set C₁ consists of odd multiples of the interval D. An audio-visual object to which a watermark signal is to be added comprises a series of signal samples identified by an index j. Each signal sample identified by its index j is subject to a corresponding dither value vⱼ. In a simple situation, the dither value vⱼ can assume binary values of 0 and 1 only; a value 0 for the dither value is indicative that even and odd multiples of the interval D are to be interpreted as 0 and 1 values respectively, whereas a value 1 for the dither value is indicative that even and odd multiples of the interval D are to be interpreted as 1 and 0 values respectively. Such QIM watermarking can be applied to a length K of the audio-visual object, namely a signal s=(s₁, . . . , s_{K}). The signal s, namely (s₁, . . . s_{K}), is watermarked using a watermark having a message b=(b₁, . . . , b_{K}) respectively such that for each index j, the signal sⱼ is moved to the nearest multiple of the interval D depending on the message value bⱼ and the dither value vⱼ; the message b is also referred to as being a symbol vector. Although the message b is a binary bit string in the embodiment described herein, it will be appreciated that the message b can derive from a larger alphabet {0, 1, . . . , M−1}. The code set C₀ can also derive from a larger alphabet {0, 1, . . . CM−1}, and similarly the code set C₁. Reference here is made to the aforementioned publication by J. Eggers et al.

During watermark detection in a given signal s′ subject to such QIM watermarking, an original corresponding message b can be determined by rounding the components of s′ to the grid spanned by the quantization interval D and then concluding a 0 bit value for every occurrence of an even multiple of the interval D. Odd multiples of the interval D with 0 dither, even multiples with 1 dither, odd multiples with 1 dither are processed similarly.

QIM watermarking is conveniently expressed mathematically as Equation 1 (Eq. 1) such that:

$${s}^{′} = [ Round ( \frac{( \frac{s}{D} + v + b )}{2} ) * 2 - v - b ] * D \qquad Eq . 1$$

wherein s/D is a quantization index for the sample value s, this index being rounded to a shifted version of the set of even integers (namely the set of even integers minus “v+b”, such that “b” is either of a value 0 or 1 and such that the dither value “v” can be any real number lying between values of −1 and +1).

When the message b has a value such that b=0 or b=1, corresponding modulated indices lie in two distinct subsets. For example, when the dither value v assumes a value 0, a zero bit corresponds to even integers; moreover, when the dither value v assumes a value 1, a one bit corresponds to even integers. When implementing Equation 1, multiplication by a factor corresponding to the interval D is applied to restore an original scale for the sample s. Thus, maximum distortion for the sample s has a value equal to the interval D.

QIM-watermarked data objects can be processed to recover watermark embedded data by computing a quantization index, applying a dither compensation and in association with such correction check for parity of results. Such recovery of the watermark embedded data is described by Equation 2 (Eq. 2):

$$\underline{b} = Mod ( Round ( \frac{s}{D} ) + v , 2 ) \qquad Eq . 2$$

wherein b=estimated message value from the recovery.

Distortion compensation is included as a part of QIM watermarking. In Equation 1 in the foregoing, the watermark sample w can be defined as a difference between the original sampled signal s and the watermarked signal s′ according to Equation 3 (Eq. 3):

s′=s+w Eq. 3

In Equation 3 (Eq. 3), the watermark sample w is interpreted as a modification introduced by watermark embedding into the sample s, or alternatively an error introduced by a quantizer. An additional parameter a is now introduced as a distortion compensation as described in Equation 4 (Eq. 4):

s′=s+(a.w) Eq. 4

When the parameter a=1, a situation as for normal QIM pertains. When the parameter a=0, no modification to achieve distortion correction is applied. The parameter a is thereby capable of being used to control the amount of distortion occurring.

As elucidated in the foregoing, QIM watermarks are sensitive to geometric transformation. When such a geometric transform is applied to a QIM watermarked audio-visual signal, the value of a sample in the transformed signal will be a weighted average of nearby sample values in a corresponding original signal. Such a value representation is provided in FIG. 1, wherein there are two neighboring pixels sᵢ and sᵢ₊₁ of a data object signal subject to watermarking, these pixels sᵢ and sᵢ₊₁ having scales denoted by 10 and 20 respectively. Both pixels 10, 20 have been quantized to a suitable level for conveying a 0-bit of watermark payload data. A middle scale 30 provides an interpolated value for a pixel rᵢ in a transformed version of the audio-visual signal. Even though a value for the pixel rᵢ is interpolated from two samples bearing the same corresponding image bits, the pixel rᵢ will decode to a value 1, instead of a value 0. Such incorrect decoding arises from one or more of three potential different causes:

(a) a difference in value between neighboring samples in a sequence of images;
(b) a difference between message (watermark payload) symbols or bits embedded at neighboring samples: and
(c) a difference between dither values at neighboring samples.

In FIG. 2, there is illustrated an interpolation error shown relative to a scale 40 caused by different sample values. Moreover, in FIG. 3, there is illustrated an interpolation error shown relative to a scale 50 caused by different watermark-payload message values. Furthermore, in FIG. 4, there is illustrated an interpolation error shown relative to a scale 60 caused by different dither values having been employed. The present invention is concerned with reducing interpolation errors resulting from these three different causes illustrated in FIGS. 2 to 4.

In the present invention, a method of adding watermark payload data onto a data object involves imposing an autocorrelation structure onto the payload data; autocorrelation structures are known and can include, for example, a repetitive watermark pattern included in images, the repetitive pattern being included by way of QIM, and the pattern being controlled with regard to its run-lengths as elucidated later. When implementing the method, a message b is embedded by quantizing each sample sᵢ in accordance with a corresponding watermark payload bit bᵢ. A complementary method of subsequently recovering the watermark payload involves four consecutive steps:

STEP 1: a watermarked signal s′ is received and decoded in a manner as if no geometrical transformation had been applied thereto. Such decoding generates an intermediate message b₁ of similar size to the watermarked signal received.

STEP 2: an estimation of the applied geometric transformation is generated by computing the autocorrelation of the detected message b₁.

STEP 3: an inverse of the estimated geometric transformation identified in STEP 2 is applied to the received signal s′ to generate a geometrically normalized received signal r.

STEP 4: the watermark is decoded from the normalized signal r, such decoding generating an output message b₂, for example bitstring.

For the method of the invention to function effectively, geometrical parameters are retrieved from the autocorrelation computed for the intermediate message b₁; for example, the geometrical parameters can relate to applied scaling or rotation.

In order to further elucidate the invention, an example of the method will now be described. In the example, a watermark bitstring b, which is embedded using a QIM embedder, is repeated every N samples in a signal s. During subsequent detection of the watermark bitstring b, when an autocorrelation of the bitstring b is computed, peaks will be visible in the autocorrelation function at positions N, 2N, 3N, and so forth.

Suppose now in the example that the watermarked signal s is scaled by a factor a to form a corresponding received signal s′. Next, the QIM detector is applied to the received signal s′. The QIM detector thereby generates a second bitstring b₁. This second bitstring b₁ will be quite different from the embedded bitstring b, but when the autocorrelation of the second bitstring b₁ is computed, peaks will still be visible which correspond to the repetition. However, due to scaling applied, the peaks will now be at positions aN, 2aN, 3aN, and so forth. Thus, knowing N and determining the autocorrelation of the bitstring b₁, it is possible to estimate a value of the scaling factor a. In a next step, the scaling having the factor a can be inverted by scaling the received signal s′ with a factor 1/a, to generate the normalized signal r. Subsequently applying the QIM detector to the normalized signal r, a bitstring b₂ is computed which should be in good correspondence with the embedded bitstring b.

Errors arising due to the second cause illustrated in FIG. 3 can be reduced by encoding the message, for example bitstring, namely the watermark payload, such that neighboring samples are encoded to have a high probability of having encoded therein a similar message value. Such a higher probability can be achieved by:

(a) repeating a message value over a pre-defined region; or
(b) by using a run-length limited code when executing encoding of the message during watermarking, wherein an encoding strategy is employed which enforces a minimum length of runs of message values having mutually similar values.

It will be appreciated that the method of the invention is equally applicable to video data objects as well as audio data objects. In this respect, forcing a minimum run length is not limited to a 1-dimensional case, for example as in audio data objects, but also to higher-order dimensions such a 2-dimensions and 3-dimensions for audio-visual data objects, for example video data objects. Such run-length control, wherein a minimum length of runs is enforced, effectively corresponds to increasing the prominence of low-frequency components included in embedded watermark message data, namely watermark data payload.

Errors arising from the third cause as illustrated in FIG. 4 can be removed, or at least reduced, by enforcing there to be a low-pass content to the dither signal. Moreover, errors arising can be further reduced by ensuring that the dither signal has a relatively small amplitude, for example less than the aforesaid interval D.

Audio, audio-visual and video objects, for example data objects, watermarked according to the invention as described in the foregoing, are susceptible to being communicated via data carriers such as CDs, DVDs, small-format optical discs, small format magnetic discs as well as via communication networks such as the Internet for example. Moreover, the method of watermark embedding as well as the complementary method of watermark detection described in the foregoing is susceptible to being implemented in hardware and/or in a data processor operating under software control.

In FIG. 6, there is shown a watermark embedder 200 according to the invention. The embedder 200, also known as an encoder, comprises a first unit 210 for receiving watermark data, namely a message b. The message b is formatted in the first unit 210, for example with regard to run-length control and hence low-frequency content, to provide data which can then be scaled with regard to parameter a and dithered via parameter v in respect of the interval D in a second unit 220 to generate an output watermark message for inputting into a third unit 230 whereat the message is imposed in a QIM manner onto the signal s to generate a watermarked signal s′.

In FIG. 5, there is shown a watermark detector 100 comprising first, second, third and fourth units 110, 120, 130, 140 respectively. The first unit 110 is operable to receive the watermarked data object signal s′ and to decode it in a manner as if no geometrical transformation had been applied to the signal s′. This decoding activity results in the generation of the message b₁ as described in the foregoing. The second unit 120 is operable to process the message b₁ by applying autocorrelation thereto to determine an estimation E of a geometric transformation applied to the signal s′. In the third unit 130 an inverse of the estimated geometric transformation is applied to the signal s′ to generate corresponding normalized received signal r. The fourth unit 140 is operable to decode the normalized signal r to generate the output message b₂. The first, second, third and fourth units 110, 120, 130, 140 respectively can be implemented in hardware, or in software executable on computing hardware, or a mixture of such implementations.

In summary, quantization index modulation (QIM) quantizes samples of a signal, for example pixels of an image or temporal samples of an audio signal, to nearest quantization levels corresponding to payload values of a watermark to be embedded into the signal. In QIM, the quantization level is optionally dithered to improve security and to mask artefacts. During subsequent watermark detection, compensation of the dither is performed after which derivation of the watermark payload from nearest quantization levels is performed.

The present invention addresses a problem that QIM is not robust with regard to geometric transformations, for example scaling. This problem is addressed at a watermark embedder by repetitively embedding a particular payload value sequence in the signal that has reinforced temporal or spatial low-frequency components.

Moreover, the invention is also concerned with complementary methods of watermark detection. The detection methods include processing steps as follows:

(a) processing a received signal to decode its payload as if no geometric transformation had been applied thereto; such processing generates a corresponding payload value sequence b₁, namely message b₁;
(b) processing the message b₁ to generate an autocorrelation function of this message b₁; this autocorrelation gives rise to autocorrelation peaks indicative of the type of transformation that has been applied to the received signal;
(c) from the applied transformation determined in step (b), a corresponding inverse transform is selected and applied to the received signal to generate a corresponding normalized signal; and
(d) processing the normalized signal to extract there from the payload, namely a message b₂, of the watermark that was embedded in the received signal. It will be appreciated that embodiments of the invention described in the foregoing are susceptible to being modified without departing from the scope of the invention as defined by the accompanying claims.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

The invention is summarized as follows. There is provided a method of detecting a watermark included in a signal by way of quantization index modulation (QIM). The watermarked signal watermark may have been geometrically transformed (e.g. spatially or temporally scaled) prior to detection. In order to detect the watermark even in such case, the embedder imposes an autocorrelation structure onto the embedded watermark data, for example by repeatedly embedding (tiling) the same data sequence. Initially, the detector applies conventional QIM detection. This step yields a first symbol vector, which represents the embedded data when the signal was not tampered with, but does not reveal the embedded data when the signal was subject to scaling. For example, when the embedder embeds one data bit in each pixel of an image, then 50% upsampling of said image will cause a QIM detector to retrieve 3 data bits out of 3 upsampled image pixels, i.e. 3 data bits out of 2 original image pixels. Surprisingly, the autocorrelation of the thus retrieved first symbol vector will give a peak for a particular geometric transformation (e.g. the particular scaling factor). In accordance with the invention, the detector calculates said autocorrelation function, and uses the result to apply the inverse of the transformation, i.e. undo the scaling. A second pass of the conventional QIM detection will subsequently receive the original embedded data.

1. A method of detecting a watermark embedded in a signal, said watermark being included in the signal by way of quantization index modulation (QIM), the method comprising steps of:
(a) receiving the signal with the watermark embedded therein;
(b) applying QIM detection to the signal to derive there from a first symbol vector from the watermark;
(c) processing the first symbol vector to determine there from a geometric transformation applied to the received signal;
(d) applying an inverse of the geometrical transformation determined in step (c) to the received signal to generate a geometrically normalized received signal; and
(e) applying QIM detection to the geometrically normalized received signal to derive there from a second symbol vector representative of the watermark embedded in the received signal.

2. A method as claimed in claim 1, wherein step (c) involves processing the first symbol vector by way of generating an autocorrelation thereof for determining the geometric transformation applied to the received signal.

3. A method as claimed in claim 1, wherein steps (b) and (e) are operable to process the received signal including at least one of: audio-visual data objects, audio data objects, images.

4. A watermark detector (100) operable to process a watermarked signal to generate a corresponding output symbol vector representative of a watermark included in the watermarked signal, said detector (100) being operable to process the watermarked signal according to the method claimed in claim 1, and said detector (100) including a processor (110, 120, 130, 140) operable to process the watermark, said watermark being incorporated into the watermarked signal by way of quantization index modulation (QIM).

5. A method of embedding a watermark into a signal by way of quantization index modulation (QIM) to generate a corresponding watermarked signal, the method including steps of:
(a) imposing an autocorrelation structure onto the watermark; and
(b) embedding the at least one symbol vector in association with the watermark into the signal to generate the watermarked signal, said signal being subject to control of the distribution of lengths of runs of symbol vector values therein having mutually similar values.

6. A method as claimed in claim 5, wherein the method is operable to embed the watermark in the signal including at least one of: audio-visual data objects, audio data objects, images.

7. A method as claimed in claim 5, wherein the method is operable to apply run-length control to the at least one symbol vector by repeating one or more watermark symbol vector values over a pre-defined region of the signal.

8. A method as claimed in claim 5, wherein the method is operable to enforce minimum lengths of runs of symbol vector values having mutually similar values.

9. A method as claimed in claim 5, wherein the watermark is embedded into the watermarked signal with a dither factor which has an amplitude which is less than a quantization interval used for the quantization index modulation (QIM).

10. An embedder (200) for embedding a symbol vector representative of a watermark into a signal to generate a watermarked signal, the embedder (200) being operable to execute the method as claimed in claim 5.

11. Software stored on a data carrier and executable on computing hardware for implementing the method as claimed in claim 1.

12. Software stored on a data carrier and executable on computing hardware for implementing the method as claimed in claim 5.

13. A watermarked signal generated according to the method as claimed in claim 5, said signal including one or more data objects disposed on a data carrier or for communication via a communication network.
